(19) United States
(12) Patent Application Publication
(10) Pub. No.: US 2015/0350219 A1
(43) Pub. Date: Dec. 3, 2015

(54) PROFILE CHANGE MANAGEMENT

(71) Applicant: TELEFONAKTIEBOLAGET L M ERICSSON (PUBL), Stockholm (SE)

(72) Inventors: Göran SELANDER, BROMMA (SE); Petter ARVIDSSON, BROMMA (SE); Miguel CARDO RODRIGUEZ, Madrid (ES); Mattias ELD, Spånga (SE)

(21) Appl. No.: 14/648,311

(22) PCT Filed: Nov. 19, 2013
(86) PCT No.: PCT/SE2013/051360

§ 371 Date: May 29, 2015

(51) Int. Cl. H04L 29/06

(52) U.S. Cl. CPC H04L 63/102; H04L 63/20

(57) ABSTRACT

It is disclosed methods and trusted execution environments (TEE) of enabling one of at least two profile domains. An authorisation token for authorising a TEE application to request one of the at least two profile domains to be enabled, is received (816, 1102). The validity of the authorization token is checked (818, 1104). If the authorization token is valid, information about the TEE application being authorised to request one of the at least two profile domains to be enabled, is stored (820, 1106). If receiving (822) a command requesting the authorised TEE application to request (824, 1108) one of the at least two profile domains to be enabled, said one of the at least two profile domains is enabled (826, 1110). A TEE comprises a processor and a memory storing a computer program comprising computer program code for executing the method when the code is run in the processor.

### TECHNICAL FIELD

This disclosure relates to profile change management for trusted execution environments. In more particular, it relates to methods and trusted execution environments of enabling a profile domain, i.e. making it enabled.

### BACKGROUND

This invention relates to trusted execution environments (TEE) and universal integrated circuit cards (UICCs). ETSI technical specification (TS) 103 383 provides requirements of the embedded UICC (eUICC). The purpose of this standard is to allow remote provisioning and management of operator “profiles” being the technical term for the programs and data which defines the subscription on a UICC having some subscriber identity module (SIM) applications. This is to enable an eUICC to be soldered to a device and never to be removed.

Use cases for UICC comprise “late binding” and “operator change” in machine-to-machine services. The former refers to the ability to define the mobile network operator (MNO) and subscription after the machine hosting the UICC has been deployed, i.e. after a SIM card has been inserted into a device. The latter refers to be able to change subscription for connectivity of the machine from one MNO to another, again without changing the SIM card.

A profile is defined to be a combination of a file structure, data and applications corresponding to the content of a current UICC. The eUICC architecture is built around the installation and management of profiles on the eUICC, which is functionally separated into two roles being the subscription manager data preparation (SM-DP) role, defining the profile and provisioning it to the eUICC, and the subscription manager secure routing (SM-SR) role, creating and deleting secure containers for the profile or SM-DP, and enabling and disabling profiles.

The SM-SR and SM-DP roles are assumed by actors in the eUICC ecosystem. Since it is of interest for operators that only one profile should be enabled at any point in time, there is a requirement that only one SM-SR can be associated with an eUICC at any point in time. But since it is also important not to lock any role to a particular actor, it is also a requirement that the SM-SR shall be changeable during the lifetime of the eUICC. This requires a procedure for handover between actors taking the old and the new SM-SR roles.

This in itself is a complicated security procedure to specify, considering that the key management required for a new SM-SR to get secure access and unique control and the old SM-SR assisting in this and at the same time giving up control of this eUICC. The old and new SM-SR are in many cases competitors, so in addition to the technical issue there may be business issues preventing an efficient handover.

Moreover, in order to change to a profile from an operator bound to a specific SM-SR a user would first have to change SM-SR and thereafter may the SM-DP associated to the operator be invoked to provision the profile. This procedure most likely slows down the change of profile in an eUICC.

There is hence a need to address the issues of SM-SR handover and how to simplify and speed up the current procedure of changing profile.

### SUMMARY

It is an object of embodiments of the invention to address at least some of the issues outlined above, and this object and others are achieved by methods and trusted execution environments for enabling one of at least two profile domains, according to the appended independent claims, and by the embodiments according to the dependent claims.

According to a first aspect, the invention provides a method for a TEE of enabling a profile domain, wherein the TEE is adapted to store at least two profile domains. The method comprises receiving an authorisation token and a command to enable one of the at least two profile domains. The method also comprises checking if the authorisation token is valid, and if the authorisation token is valid, the method also comprises enabling said one of the at least two profile domains.

According to a second aspect, the invention provides a trusted execution environment (TEE) adapted to store at least one of at least two profile domains. The TEE comprise a processor and a memory storing a computer program comprising computer program code which when run in the processor, causes the TEE to receive an authorisation token and a command to enable one of the at least two profile domains, and to check if the authorisation token is valid. When the computer program code is run in the processor, it also causes the TEE to enable said one of the at least two profile domains, if the authorisation token is valid.

According to a third aspect, the invention provides a method for a TEE of enabling a profile domain, wherein the TEE is adapted to store at least two profile domains. The method comprises receiving an authorisation token for authorising a TEE application to request one of the at least two profile domains to be enabled. The method also comprises checking if the authorization token is valid, and if the authorisation token is valid, the method comprises storing information about the TEE application being authorised to request one of the at least two profile domains to be enabled. The method also comprises requesting by said authorised TEE application one of the at least two profile domains to be enabled. In addition, the method comprises enabling said one of the at least two profile domains.

According to a fourth aspect, the invention provides a TEE adapted to store at least one of at least two profile domains, the TEE comprising a processor and a memory storing a computer program comprising computer program code which when run in the processor, causes the TEE to receive an authorisation token for authorising a TEE application to request one of the at least two profile domains to be enabled. When the computer program code is run in the processor, it further causes the TEE check if the authorisation token is valid; and if the authorisation token is valid, it causes the TEE to store information about the TEE application being authorised to request one of the at least two profile domains to be enabled. When the computer program code is run in the processor, it also causes the TEE to request, by said authorised TEE application, one of the at least two profile domains to be enabled. In addition, when the computer program code is run in the processor, it causes the TEE to enable said one of the at least two profile domains.

It is an advantage with embodiments of the invention that a new profile domain can be deployed and enabled without requiring a handover procedure between actors taking the old and the new SM-SR roles. This simplifies and speeds up the procedure of changing profile.

### BRIEF DESCRIPTION OF THE DRAWINGS

Embodiments will now be described in more detail, and with reference to the accompanying drawings, in which:

FIG. 1 schematically presents a logical architecture of a UICC having associations to subscription manager roles, according to embodiments of the invention;

FIG. 2 schematically presents a universal integrated circuit card of embodiments of the invention;

FIGS. 3, 4, 8A and 8B present handshake diagrams of embodiments of the invention;

FIGS. 5, 6, 9 and 10 schematically present trusted execution environments of embodiments of the invention; and

FIGS. 7 and 11 present flow-charts of methods of embodiments of the invention.

### DETAILED DESCRIPTION

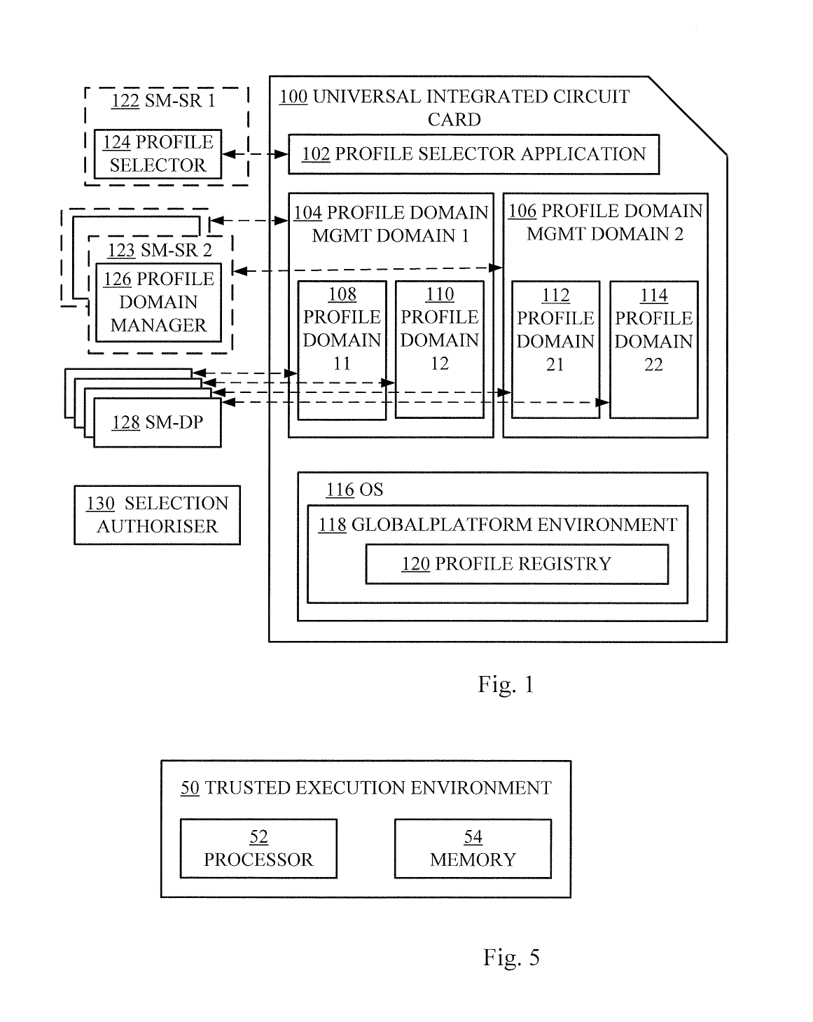

In the following description, different embodiments of the invention will be described in more detail, with reference to accompanying drawings. For the purpose of explanation and not limitation, specific details are set forth, such as particular examples and techniques in order to provide a thorough understanding. FIG. 1 schematically presents a logical architecture of a universal integrated circuit card (UICC) 100, being one example of a trusted execution environment, according to embodiments of the invention. In addition, associations between security domains (SDs) and subscription manager roles are indicated. The UICC 100 comprises a profile selector application 102 that can receive information about an application for enabling a profile domain. The UICC further comprises two management domains of profile domains. These management domains are profile domain management domain 1, 104, and profile domain management domain 2, 106. Profile domain management domain 1, 104 comprises profile domain 11, 108 and profile domain 12, 110. Profile domain management domain 2, 106 comprises profile domain 21, 112 and profile domain 22, 114.

The UICC 100 also comprises an operative system (OS) comprising a GlobalPlatform environment 118. This GlobalPlatform environment 118 comprises a profile registry 120. In addition, FIG. 1 schematically indicates a subscription manager secure routing 1 (SM-SR) 122 role comprising a profile selector 124. Another subscription manager secure routing, SM-SR 2, 123 role comprises a profile domain manager 126. More SM-SRs may also exist each having a profile domain manager. A subscription manager data preparation (SM-DP) role of a subscription manager is also shown. Indications between SDs of the UICC and subscription manager roles are also presented.

According to some embodiments of the invention, each profile domain manager is represented by a modified security domain (SD) in the form of a profile domain management domain that is similar to current profile managers of today, with the exception that it is not handling profile enabling and disabling. Since the profile domain management function is separated from the profile selection function, there is no issue with having multiple instances of profile domain management domain. Hence concurrent management of profiles is possible without losing control of enabled profiles, since profile selection is not performed by this role.

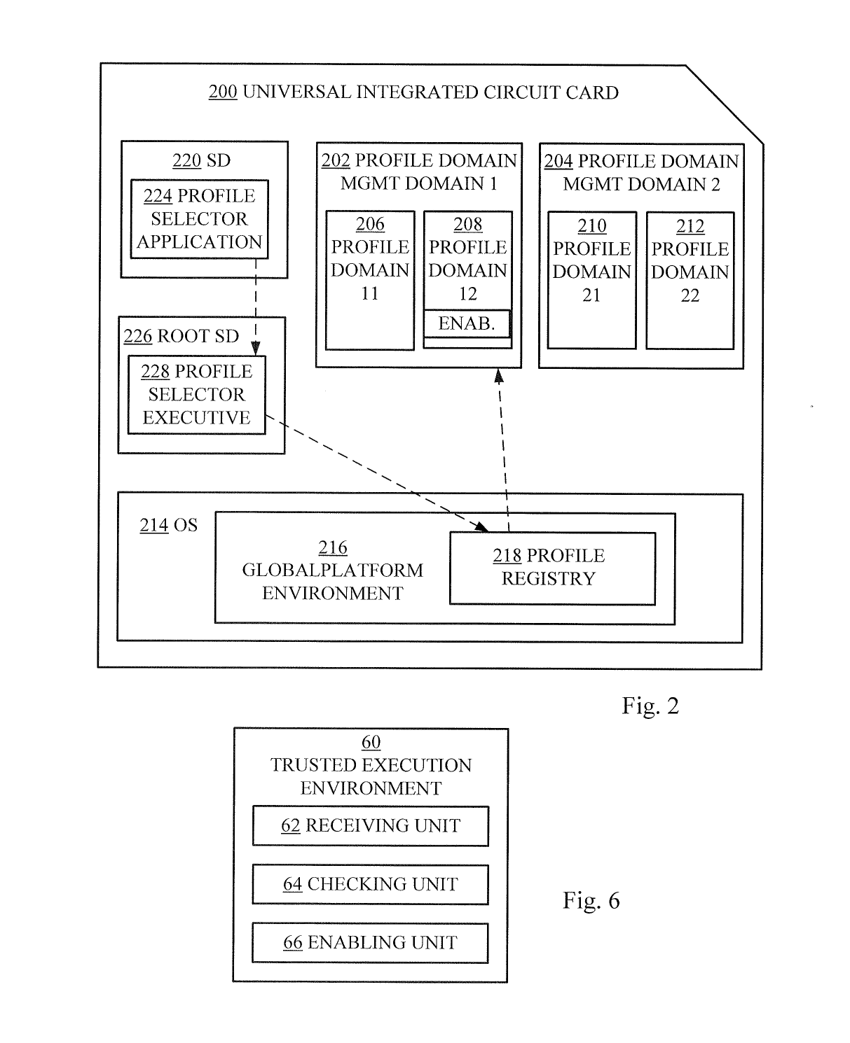

FIG. 2 schematically presents a UICC 200 according to embodiments of the invention. The UICC comprises two management domains of profile domains. These management domains are profile domain management domain 1, 202, and profile domain management domain 2, 204. Profile domain management domain 1, 202 comprises profile domain 11, 206 and profile domain 12, 208. Profile domain management domain 2, 204 comprises profile domain 21, 210 and profile domain 22, 212. The profile domain management domains can comprise zero or more profile domains.

The UICC 200 also comprises a security domain (SD) 220 and a root SD 226. The SD 220 comprises a profile selector application 224. The root SD 226 comprises a profile selector executive 228. The SD 220 may coincide with the root SD 226. The profile selector application 224 may coincide with the profile selector executive 228.

In addition, the UICC 200 comprises an operative system (OS) having a GlobalPlatform environment 216, wherein said GlobalPlatform environment is extended with a profile registry 218 comprising at least two entries of identifiers of profile domains present in the UICC.

As will be discussed in more detail below, the profile selector application 224 can request or command a profile selector executive 228 to enable a profile domain either by checking that an authorisation token is valid for a request to enable one of at least two profile domains, or by checking that the profile selector application 224 is authorised to request enabling one of at least two profile domains. In FIG. 2 it is indicated that profile domain 12, 208 is enabled by the profile selector executive. This is performed via an entry in the profile registry 218 having an identifier of the profile domain 12, 208.

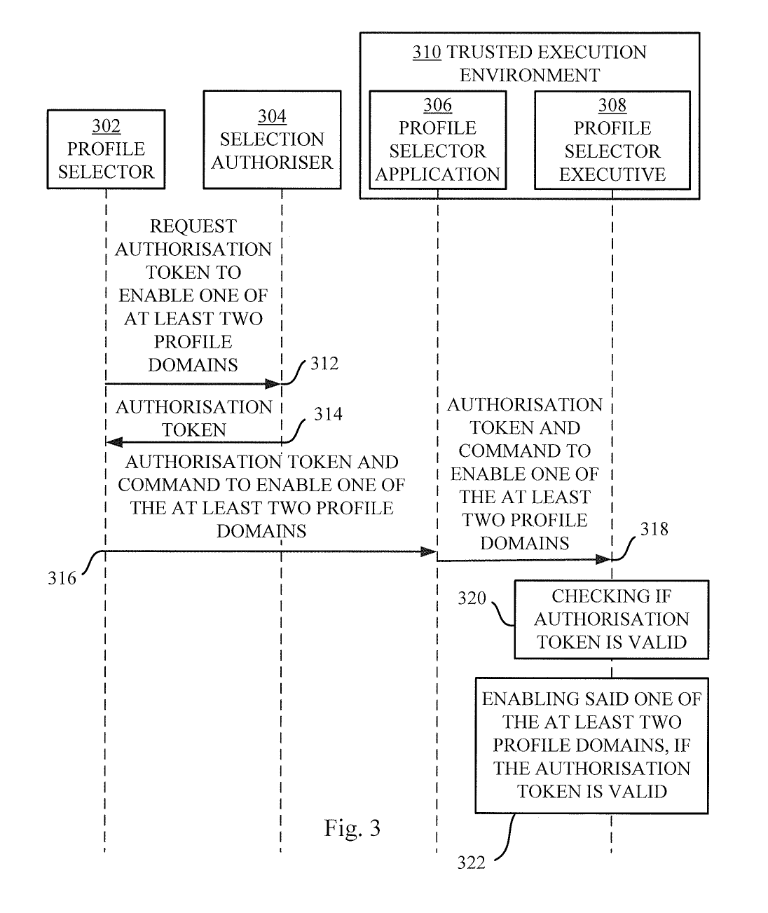

FIGS. 3 to 7 will relate to the former usage of an authorisation token in which checking whether the authorisation token is valid or not relates to authorising the request for enabling one of at least two profile domains.

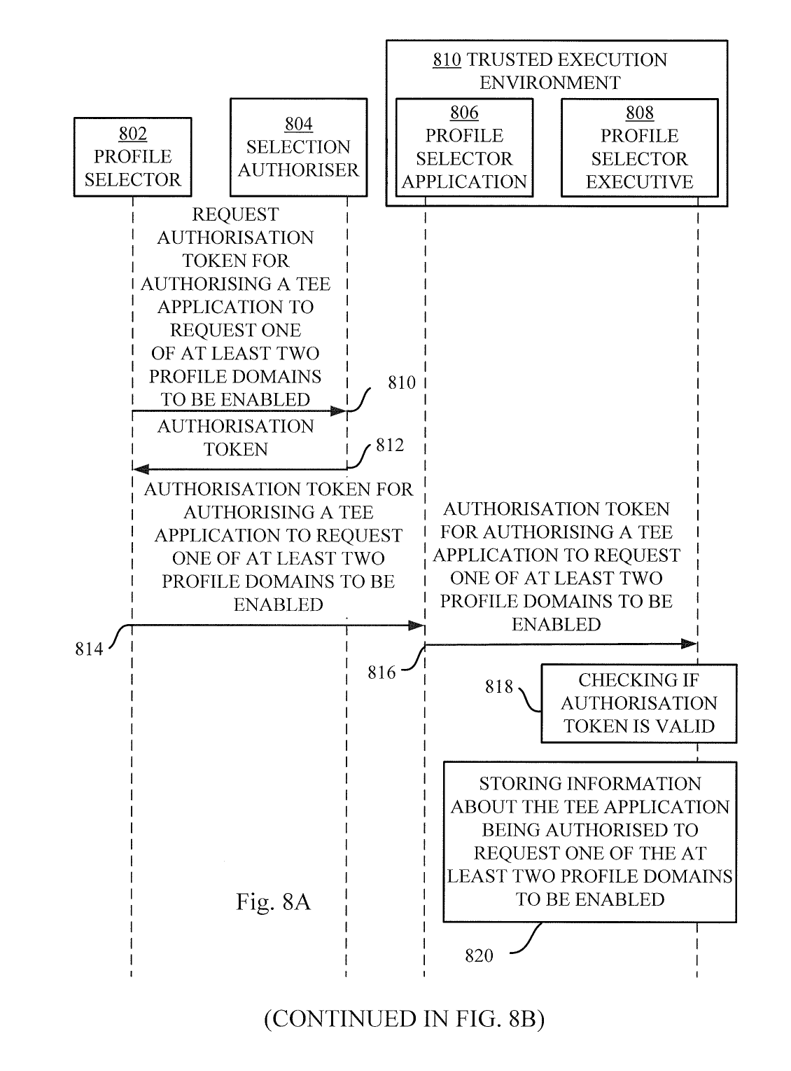

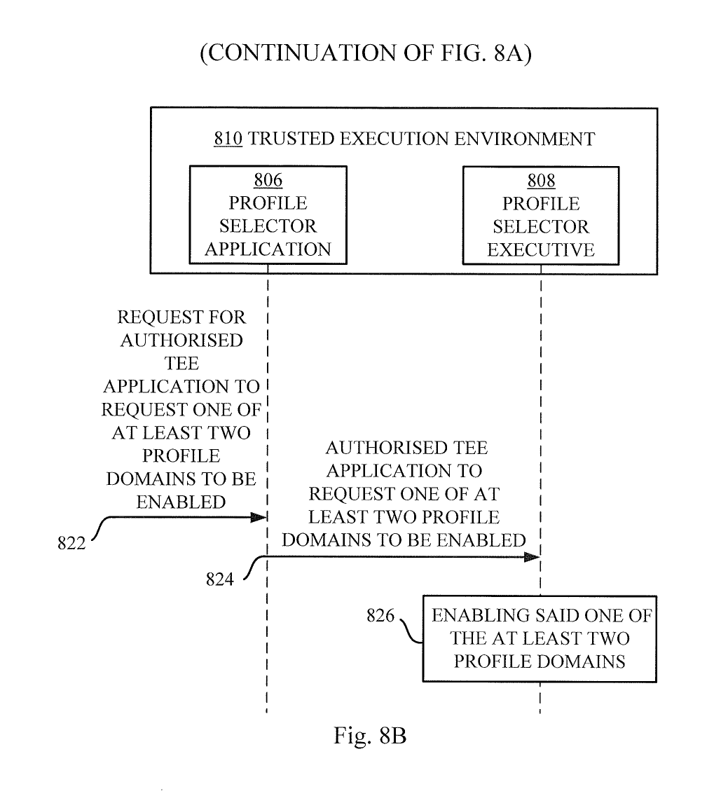

FIGS. 8 to 11 relate to the latter usage of an authorisation token in which checking whether the authorisation token is valid or not relates to authorising an application to request one of at least two profile domains to be enabled.

FIG. 3 presents a signaling diagram of embodiments of the invention, comprising signaling between profile selector 302, selection authoriser 304, and a trusted execution environment (TEE) 310. The profile selector 302 and the selection authoriser 304 are external to the TEE 310. The TEE comprises a profile selector application 306 and a profile selector executive 308.

When the profile selector 302 wishes to enable one or at least two profile domains, an authorisation token is required. The profile selector 302 hence requests 312 an authorisation token to enable one of at least two profile domains from the selection authoriser 304. The selection authoriser 304 authorises the request 312 by issuing an authorisation token, and returns 314 said authorisation token to the profile selector 302. The request is thus authorised by the issued authorisation token.

Having accessed this authorisation token, the profile selector 302 sends, to a profile selector application 306, 316 this authorisation token and a command to enable one of at least two profile domains. The profile selector application 306 forwards 318 the request, comprising the authorisation token and the command to enable one of at least two profile domains, to the profile selector executive 308 of the TEE 310. The profile selector executive now checks 320 if the authorisation token is valid. If the authorisation token is valid, the profile selector executive enables 322 one of at least two profile domains.

Information about which one of the at least two profile domains to enable for this request may be comprised in the command. Alternatively, such information are stored in advance in the profile selector executive 308.

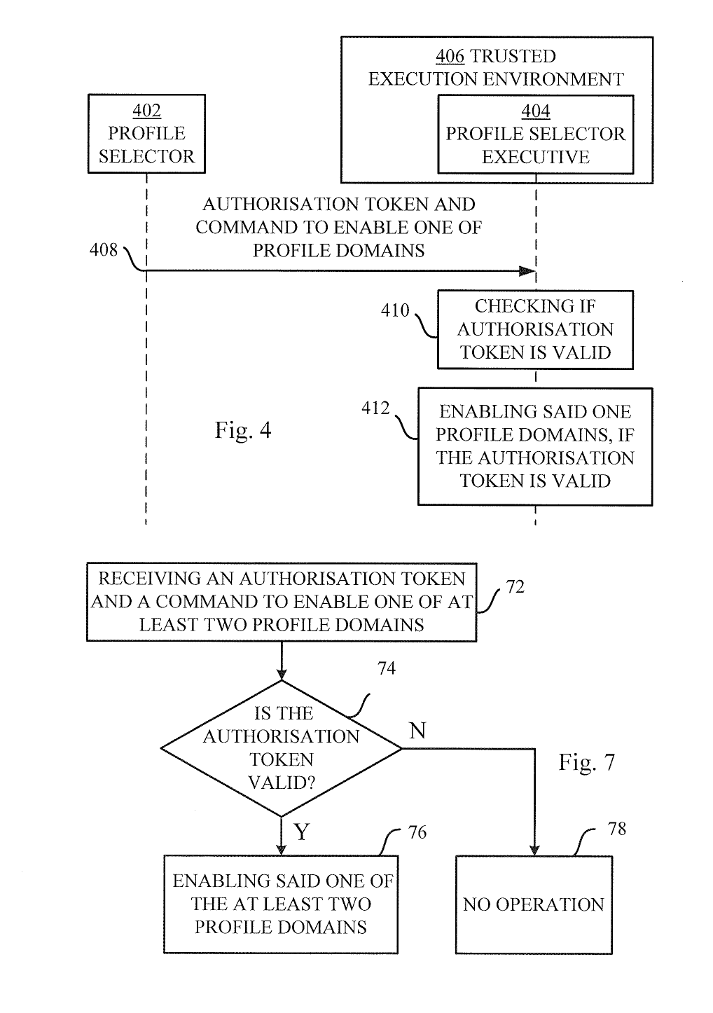

FIG. 4 presents a signaling diagram of alternative embodiments of the invention, comprising signaling between profile selector 402, and a trusted execution environment (TEE) 406. The profile selector 402 typically comprises an internal selection authoriser. The TEE comprises a profile selector executive 404.

When the profile selector 402 wishes to enable a profile domain, the profile selector 402 sends 408 an authorisation token and a command to enable one of at least two profile domains to the TEE 406. According to these embodiments, the authorisation token and the command can be sent directly to the profile selector executive 404. The profile selector executive 404 checks 410 if the authorisation token is valid. If the authorisation token is valid, the profile selector executive 404 enables 412 said one of the at least two profile domains.

Checking if authorisation tokens are valid, i.e. validation of authorisation tokens, may be performed in various ways. Asymmetric cryptographic keys, such as public keys, as well as symmetric cryptographic keys, such as shared secret keys, may be used to validate authorisation tokens. According to an alternative embodiment, the profile selector comprises a selection authoriser, whereas the TEE comprises a profile selection application as well as a profile selector executive. Alternatively, the profile selector and the selection authoriser are separated whereas the profile selector executive comprises a profile selector application.

FIG. 5 schematically presents a TEE 50 comprising a processor 52 and a memory 54. The TEE 50 is adapted for enabling one of at least two profile domains. The memory 54 stores a computer program comprising computer program code which when run in the processor, causes the TEE to receive 316, 408 an authorisation token and a command to enable one of the at least two profile domains, and to check 320, 410 if the authorisation token is valid. When the computer program code is run in the processor, it also causes the TEE to enable 322, 412 said one of the at least two profile domains, if the authorisation token is valid.

The computer program code which when run in the processor, may further cause the TEE to check that enabling said one of the at least two profile domains is in agreement with a policy for said one of the at least two profile domains.

The computer program code which when run in the processor, may further cause the TEE to receive 316 the authorisation token and the command by a first TEE-application 306, and to send 318 a request by the first TEE application 306 to a second TEE application 308, wherein the request comprises the authorisation token, based on the received command, for enabling of one of the at least two profile domains. The computer program code which when run in the processor, can further cause the TEE to check 320 and enable 322 one of the at least two profile domains by the second TEE application 308.

The TEE 50 may further comprise a profile registry 120, 218 that comprises identifiers of the at least two profile domains 108, 110, 112, 114; 206, 208, 210, 212.

The TEE 50 may further comprise a universal integrated circuit card (UICC) 100, 200.

FIG. 6 presents a TEE 60 that is adapted to store at least two profile domains and that is adapted for enabling one of said at least two profile domains. The TEE comprises a receiving unit 62 that is adapted to receive an authorisation token and a command to enable one of the at least two profile domains. The TEE also comprises a checking unit 64 that is adapted to check if the authorisation token is valid. In addition, the TEE comprises an enabling unit 66 that is adapted to enable said one of the at least two profile domains, if the authorisation token is valid.

FIG. 7 illustrates a flowchart of a method for a TEE 50, 60, 310, 406 of enabling a profile domain, wherein the TEE is adapted to store at least two profile domains 108, 110, 112, 114; 206, 208, 210, 212. In 72 the method comprises receiving an authorisation token and a command to enable one of the at least two profile domains. In 74 it is checked if the authorisation token is valid. If the authorisation token is valid in 74, the method comprises enabling said one of the at least two profile domains, in 76. If, however, the authorisation token is not valid, no operation is performed in 78.

The method of enabling a profile domain may further comprise checking that enabling said one of the at least two profile domains is in agreement with a policy for said one of the at least two profile domains.

The method of enabling a profile domain for a TEE 50, 60, 310, comprising a first TEE application and a second TEE application, may further comprise receiving 316 the authorisation token and the command by the first TEE-application. The method may comprise sending a request 318, comprising the authorisation token, by the first TEE application 306, to the second TEE application 308, based on the received 316 command, for enabling of one of the at least two profile domains. In addition, checking 320 and enabling 322 may be performed by the second TEE application 308.

As mentioned above, FIGS. 8A to 11 relate to a usage of an authorisation token in which checking if the authorisation token is valid relates to authorising an application to request one of at least two profile domains to be enabled.

FIGS. 8A and 8B present a signaling diagram of embodiments of the invention, comprising signaling between profile selector 802, selection authoriser 804, and a trusted execution environment (TEE) 810. The profile selector 802 and the selection authoriser 804 are external to the TEE 810. The TEE comprises a profile selector application 806 and a profile selector executive 808.

When the actor profile selector 802 wishes to enable one or at least two profile domains by using a TEE application the profile selector 802 requests 810 an authorisation token for authorising a TEE application to request one of at least two profile domains to be enabled. The selection authoriser 804 authorises the TEE application to request one of at least two profile domains to be enabled by issuing an authorisation token, and returns 812 said authorisation token to the profile selector 802. The TEE application is thus authorised by the issued authorisation token. However, as will be described below the authorisation token has to be validated in order for the TEE application to be authorised to request one of at least two profile domains to be enabled.

Having accessed this authorisation token, the profile selector 802 sends 814 the authorisation token for authorising a TEE application to request one of at least two profile domains to be enabled to the profile selector application 806. The profile selector application 806 forwards 816 the request, comprising the authorisation token to the profile selector executive 808 of the TEE 810. The profile selector executive 808 now checks 818 if the authorisation token is valid. If the authorisation token is valid, the profile selector executive stores 820 information about the TEE application being authorised to request one of at least two profile domains to be enabled. This means that the profile selector application 806 is authorised to request one of at least two profile domains to be enabled.

FIG. 8A is now continued in FIG. 8B.

The profile selector executive 808 has hence authorised the TEE application to request one of at least two profile domains to be enabled. This means that when the TEE 810 is received by an external request for the authorised TEE application to request one of at least two profile domains to be enabled, the profile selector application 806 being the authorised TEE application sends a request for one of at least two profile domains to be enabled, to the profile selector executive 808. As the profile selector application 806 now is authorised and profile selector executive has information about this authorisation, the profile selector executive 808 enables 826 one of at least two profile domains to be enabled.

Needless to say, if the TEE 810 is received by a request for a non-authorised application to request one of at least two profile domains to be enabled, the request is denied.

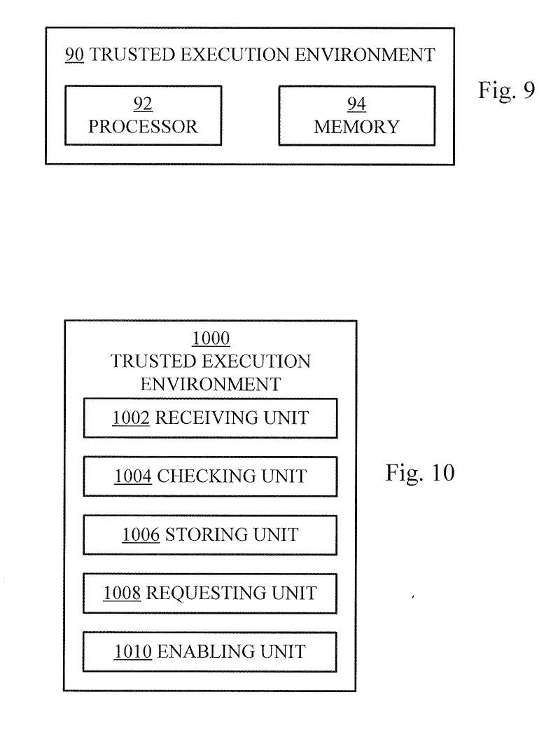

FIG. 9 schematically presents a TEE 90 comprising a processor 92 and a memory 94. The TEE 90 is adapted for enabling one of at least two profile domains. The memory 94 stores a computer program comprising computer program code which when run in the processor, causes the TEE to receive 816 an authorisation token for authorising a TEE application to request one of the at least two profile domains to be enabled. When the computer program code is run in the processor, it further causes the TEE check 818 if the authorisation token is valid; and if the authorisation token is valid, it causes the TEE to store 820 information about the TEE application being authorised to request one of the at least two profile domains to be enabled. When the computer program code is run in the processor, it also causes the TEE to request 824, by said authorised TEE application, one of the at least two profile domains to be enabled. In addition, when the computer program code is run in the processor, it causes the TEE to enable 826 said one of the at least two profile domains.

The computer program code which when run in the processor 92 may further cause the TEE to check that enabling said one of the at least two profile domains is in agreement with a policy for said one of the at least two profile domains.

The computer program code which when run in the processor 92 may further cause the TEE receive 822 a message for said authorised TEE application to request one of the at least two profile domains to be enabled.

The computer program code which when run in the processor 92, may further cause the TEE 90 to receive 814 the authorisation token by said first TEE application 806 or by one other TEE application, and to check 818, store 820 and enable 826 by a second other TEE application 808.

The computer program code which when run in the processor 92, may further cause the TEE to receive the message 822 by the authorised TEE application 806, to request the second other TEE application 808 to enable said one of the at least two profile domains 108, 110, 112, 114; 206, 208, 210, 212.

The computer program code which when run in the processor, may further cause the TEE to store 820 an application identifier of said authorised TEE application in a list of TEE applications being authorised to request one of at least two profile domains to be enabled.

The TEE 90 may further comprise a profile registry 120, 218 that comprises identifiers of the at least two profile domains.

The TEE 90 may comprise a universal integrated circuit card, UICC 100, 200.

FIG. 10 presents a TEE 1000 that is adapted to store at least two profile domains and that is adapted for enabling one of said at least two profile domains 108, 110, 112, 114; 206, 208, 210, 212. The TEE comprises a receiving unit 1002 that is adapted to receive an authorisation token for authorising a TEE application to request one of the at least two profile domains to be enabled. The TEE further comprises a checking unit 1004 that is adapted to check if the authorisation token is valid, and a storing unit 1006 that is adapted to store information about the TEE application being authorised to request one of the at least two profile domains to be enabled, if the authorisation token is valid. The TEE also comprises a requesting unit 1008 that is adapted to request, by said authorised TEE application, one of the at least two profile domains to be enabled. In addition, the TEE comprises an enabling unit 1010 that is adapted to enable said one of the at least two profile domains.

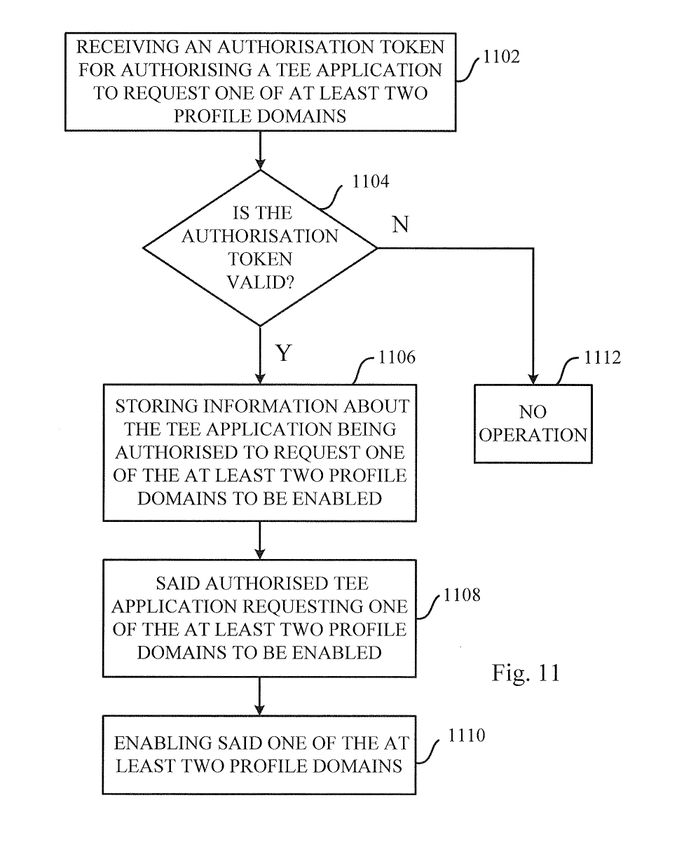

FIG. 11 illustrates a flowchart of a method for a TEE 90, 810, 1000 of enabling a profile domain, wherein the TEE is adapted to store at least two profile domains 108, 110, 112, 114; 206, 208, 210, 212. In 1102 the method comprises receiving an authorisation for authorising a TEE application to request one of the at least two profile domains to be enabled. In 1104 the authorisation token is checked if it is valid. If the authorisation token is valid in 1104, the flowchart comprises storing 1106 information about the TEE application being authorised to request one of the at least two profile domains to be enabled. In 1108, the flowchart comprises application requesting 824 by said authorised TEE one of the at least two profile domains to be enabled. In 1110, the flowchart also comprises enabling 826 said one of the at least two profile domains.

The method of the flowchart may further comprise checking that enabling said one of the at least two profile domains is in agreement with a policy for said one of the at least two profile domains.

The method of the flowchart may further comprise receiving 822 a message for said authorised TEE application to request 824 one of the at least two profile domains to be enabled.

The method of the flowchart may further comprise receiving the authorisation token by said first TEE application 806 or by one other TEE application, and wherein checking 818, storing 820 and enabling 826 is performed by a second other TEE application 808.

Said one other TEE application may be a security domain application of the TEE.

The method of the flowchart wherein the authorised TEE application 806 may receive 822 the message and wherein second other TEE application 808 may be requested 824 to enable said one of the at least two profile domains.

The method of the flowchart wherein storing may comprise storing an application identifier of said authorised TEE application in a list of TEE applications being authorised to request one of at least two profile domains to be enabled.

The present invention has the following advantages:

Embodiments of the present invention provide means for making the SM-SR non-discriminatory with respect to other entities in the ecosystem.

It may be further noted that the above described embodiments are only given as examples and should not be limiting to the present invention, since other solutions, uses, objectives, and functions are apparent within the scope of the invention as claimed in the accompanying patent claims.

### ABBREVIATIONS

eUICC—embedded UICC
MNO—mobile network operator
SM-DP—subscription manager data preparation
SM-SR—subscription manager secure routing
OS—operation system
SD—security domain
SIM—subscriber identity module
TEE—trusted execution environment
UICC—universal integrated circuit card

1. A method for a trusted execution environment, TEE, of enabling a profile domain, wherein the TEE is adapted to store at least two profile domains, the method comprising:
receiving an authorisation token and a command to enable one of the at least two profile domains;
checking if the authorisation token is valid; and
if the authorisation token is valid, enabling said one of the at least two profile domains.

2. The method according to claim 1, further comprising checking that enabling said one of the at least two profile domains is in agreement with a policy for said one of the at least two profile domains.

3. The method according to claim 1, for which the TEE comprises a first and a second TEE-application, and wherein the authorisation token and the command is received by the first TEE-application, the method comprising, the first TEE application sending a request, that comprises the authorisation token, to the second TEE application, based on the received command, for enabling of one of the at least two profile domains, and wherein checking and enabling is performed by the second TEE application.

4. A trusted execution environment, TEE, adapted to store at least two profile domains and adapted for enabling one of said at least two profile domains, the TEE comprising:
a receiving unit adapted to receive an authorisation token and a command to enable one of the at least two profile domains;
a checking unit adapted to check if the authorisation token is valid;
an enabling unit adapted to enable said one of the at least two profile domains, if the authorisation token is valid.

5. A trusted execution environment, TEE, adapted for enabling one of at least two profile domains, the TEE comprising:
a processor; and
a memory storing a computer program comprising computer program code which when run in the processor, causes the TEE to:
receive an authorisation token and a command to enable one of the at least two profile domains;
check if the authorisation token is valid;
enable said one of the at least two profile domains, if the authorisation token is valid.

6. The TEE according to claim 5, wherein the computer program code which when run in the processor, further causes the TEE to check that enabling said one of the at least two profile domains is in agreement with a policy for said one of the at least two profile domains.

7. The TEE according to claim 5, wherein the computer program code which when run in the processor, causes the TEE: to receive the authorisation token and the command by a first TEE-application, to send a request by the first TEE application to a second TEE application, the request comprising the authorisation token, based on the received command, for enabling of one of the at least two profile domains, and to check and enable one of the at least two profile domains by the second TEE application.

8. The TEE, according to claim 5, further comprising a profile registry that comprises identifiers of the at least two profile domains.

9. The TEE, according to claim 5, wherein the TEE comprises a universal integrated circuit card, UICC.

10. A method for a trusted execution environment, TEE, of enabling a profile domain, wherein the TEE is adapted to store at least two profile domains, the method comprising:
receiving an authorisation token for authorising a TEE application to request one of the at least two profile domains to be enabled;
checking if the authorisation token is valid; and if the authorisation token is valid:
storing information about the TEE application being authorised to request one of the at least two profile domains to be enabled;
said authorised TEE application requesting one of the at least two profile domains to be enabled, and
enabling said one of the at least two profile domains.

11. The method according to claim 10, further comprising checking that enabling said one of the at least two profile domains is in agreement with a policy for said one of the at least two profile domains.

12. The method according to claim 10, further comprising receiving a message for said authorised TEE application to request one of the at least two profile domains to be enabled.

13. The method according to claim 10, wherein the authorisation token is received by said first TEE application or by one other TEE application, and wherein checking, storing and enabling is performed by a second other TEE application.

14. The method according to claim 13, wherein the authorised TEE application receives the message and wherein second other TEE application is requested to enable said one of the at least two profile domains.

15. The method according to claim 10, wherein storing information about the TEE application being authorised to request one of the at least two profile domains to be enabled, comprises storing an application identifier of said authorised TEE application in a list of TEE applications being authorised to request one of at least two profile domains to be enabled.

16. A trusted execution environment, TEE, adapted for enabling one of at least two profile domains, the TEE comprising:
a receiving unit adapted to receive an authorisation token for authorising a TEE application to request one of the at least two profile domains to be enabled;
a checking unit adapted to check if the authorisation token is valid;
a storing unit adapted to store information about the TEE application being authorised to request one of the at least two profile domains to be enabled, if the authorisation token is valid;
a requesting unit adapted to request, by said authorised TEE application, one of the at least two profile domains to be enabled; and
an enabling unit adapted to enable said one of the at least two profile domains.

17. A trusted execution environment, TEE, adapted for enabling one of at least two profile domains, the TEE comprising:
a processor; and
a memory storing a computer program comprising computer program code which when run in the processor, causes the TEE to:
receive an authorisation token for authorising a TEE application to request one of the at least two profile domains to be enabled;
check if the authorisation token is valid; and if the authorisation token is valid:
store information about the TEE application being authorised to request one of the at least two profile domains to be enabled;
request, by said authorised TEE application, one of the at least two profile domains to be enabled; and
enable said one of the at least two profile domains.

18. The TEE according to claim 17, wherein the computer program code which when run in the processor, further causes the TEE to check that enabling said one of the at least two profile domains is in agreement with a policy for said one of the at least two profile domains.

19. The TEE according to claim 17, wherein the computer program code which when run in the processor, further causes the TEE to receive a message for said authorised TEE application to request one of the at least two profile domains to be enabled.

20. The TEE according to claim 17, wherein the computer program code which when run in the processor, further causes the TEE to receive the authorisation token by said first TEE application or by one other TEE application, and to check, store and enable by a second other TEE application.

21. The TEE according to claim 20, wherein the computer program code which when run in the processor, further causes the TEE to receive the message by the authorised TEE application, to request the second other TEE application to enable said one of the at least two profile domains.

22. The TEE according to claim 17, wherein the computer program code which when run in the processor, further causes the TEE to store an application identifier of said authorised TEE application in a list of TEE applications being authorised to request one of at least two profile domains to be enabled.

23. The TEE, according to claim 17, further comprising a profile registry that comprises identifiers of the at least two profile domains.

24. The TEE, according to claim 17, wherein the TEE comprises a universal integrated circuit card, UICC.
